(19) United States
(12) Patent Application Publication
(10) Pub. No.: US 2026/0097342 A1
(43) Pub. Date: Apr. 9, 2026

(54) PANEL MOUNTED CLEAN AIR SYSTEM

(71) Applicant: Geiser, Inc., Phoenix, AZ (US)

(72) Inventor: Sean Geiser, Phoenix, AZ (US)

(21) Appl. No.: 18/910,422

(22) Filed: Oct. 9, 2024

(51) Int. Cl. B01D 46/00; A42B 3/04; B01D 46/10; B60H 3/06

(52) U.S. Cl. CPC B01D 46/0005; A42B 3/0406; B01D 46/0047; B01D 46/10; B60H 3/0658; B01D 2271/027; B01D 2273/30; B01D 2279/40

(57) ABSTRACT

A panel mounted clean air system is provided. The panel mounted clean air system may include an air intake having an opening, a filter and a gasket coupled to the air intake, wherein the filter covers the opening of the air intake. The system further includes a fan coupled to the air intake, an outlet coupled to the fan, and a mounting bracket. The mounting bracket may couple the air intake to a flat panel of a vehicle and couples the filter and the gasket to the air intake. The fan operates to draw air in through the air intake and directs it through the outlet to a specified location.

### BACKGROUND OF THE INVENTION

### Technical Field

This invention relates generally to an air supply system for a vehicle, and more particularly to a panel mounted clean air system.

### State of the Art

Drivers that race vehicles are often in need of having a supply of air for various reasons. One of the main reasons includes the ability to breath clean or filtered air during a race. Ambient air may be filled with dust, exhaust and other contaminants that may be inhaled by a driver, a passenger, or the like during a race. The air supply system includes an air supply and hoses that delivers clean or filtered air to a driver or passenger wearing a forced air helmet or the equivalent. These air supply systems are lacking in the ability to keep hoses hidden and to utilize components already a part of the vehicle that is being driven. Another reason for wanting a supply of clean air is to direct to specified locations such as, but not limited to CV axles. There does not exist a system that can easily mount to a vehicle to add a clean air supply system.

Accordingly, there is a need for a panel mount clean air system.

### SUMMARY OF THE INVENTION

An embodiment includes a panel mounted clean air system comprising: an air intake having an opening; a fan coupled to the air intake; and an outlet coupled to the fan, wherein; the air intake is coupled to a flat panel of a vehicle; and the fan operates to draw air in through the air intake and directs it through the outlet to a specified location.

Another embodiment includes a panel mounted clean air system comprising: an air intake having an opening; a filter and a gasket coupled to the air intake, wherein the filter covers the opening of the air intake; a fan coupled to the air intake; an outlet coupled to the fan; a mounting bracket; and an auxiliary bracket, wherein: the mounting bracket couples the air intake to the auxiliary bracket and couples the filter and the gasket to the air intake wherein; the auxiliary bracket couples the air intake is to a flat panel of a vehicle; and the fan operates to draw air in through the air intake and directs it through the outlet to a specified location.

Another embodiment includes a method of using a panel mounted clean air system, the method comprising: coupling a panel mounted clean air system to a flat panel of a UTV, the panel mounted clean air system comprising: an air intake having an opening; a filter and a gasket coupled to the air intake, wherein the filter covers the opening of the air intake; a fan coupled to the air intake; and an outlet coupled to the fan; operating the fan to draw air in through the filter and the air intake; filtering the air in response to drawing the air in through the filter; and directing the air through the outlet to a specified location.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a panel mounted clean air system, according to an embodiment;

FIG. 2A is a perspective view of a panel mounted clean air system, according to an embodiment;

FIG. 2B is a perspective view of a panel mounted clean air system with a screening media removed, according to an embodiment;

FIG. 3 is a perspective view of a panel mounted clean air system with a mounting bracket, according to an embodiment;

FIG. 4 is an exploded perspective view of a panel mounted clean air system with a mounting bracket, according to an embodiment;

FIG. 5 is a perspective view of a panel mounted clean air system coupled to a roof skin, according to an embodiment;

FIG. 6 is a perspective view of a panel mounted clean air system coupled to a roof skin, according to an embodiment;

FIG. 7 is a perspective view of a panel mounted clean air system coupled to a roof skin with hoses to supply air to helmets, according to an embodiment; and

FIG. 8 is a perspective view of a panel mounted clean air system coupled to a roof skin with hoses to supply air to helmets, according to an embodiment.

### DETAILED DESCRIPTION OF EMBODIMENTS OF THE INVENTION

As discussed above, embodiments of the present invention relate to a panel mounted clean air system, wherein the system operates to direct and force air to a specified location, such as, but not limited to helmets, cv axles, and the like.

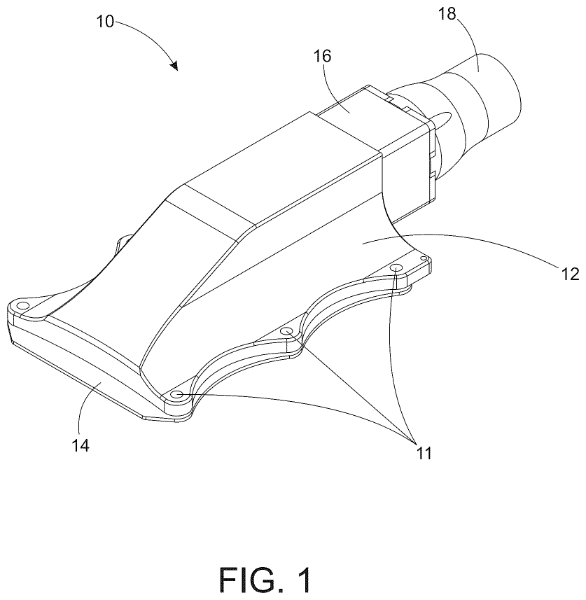

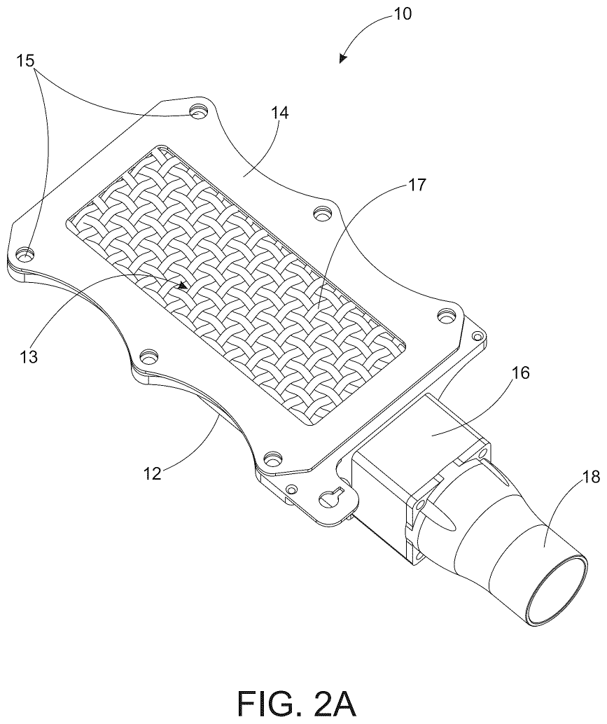

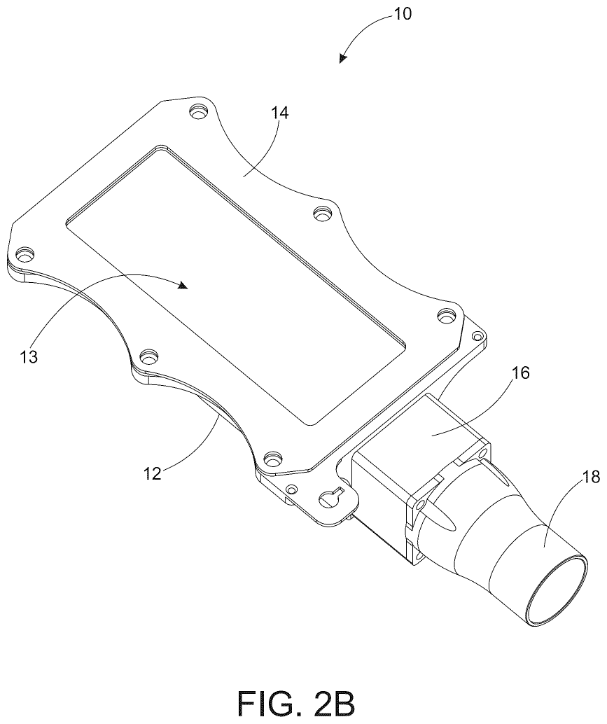

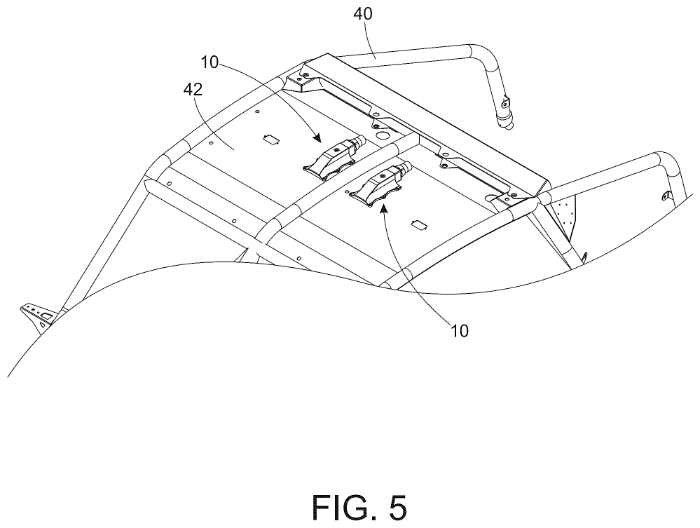

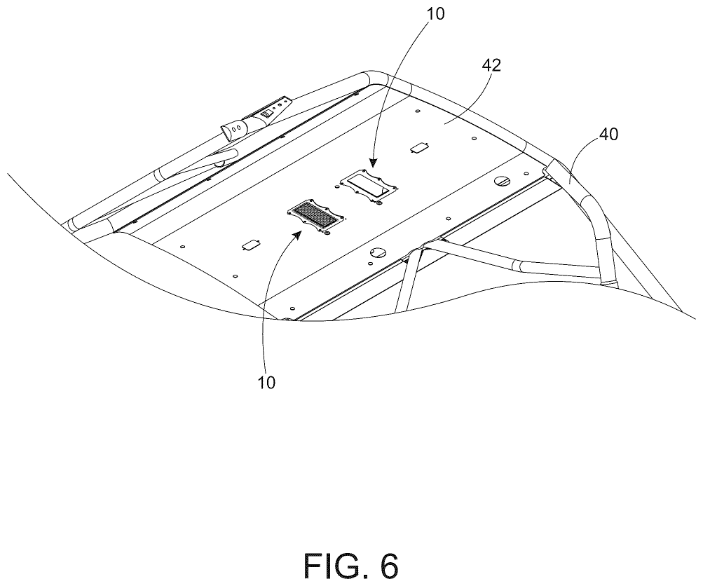

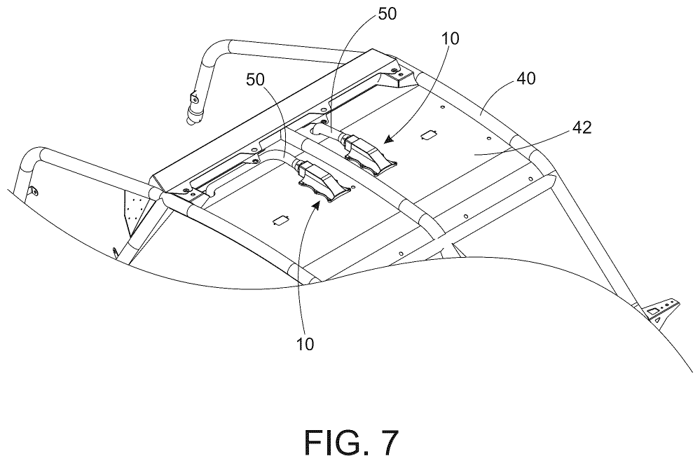

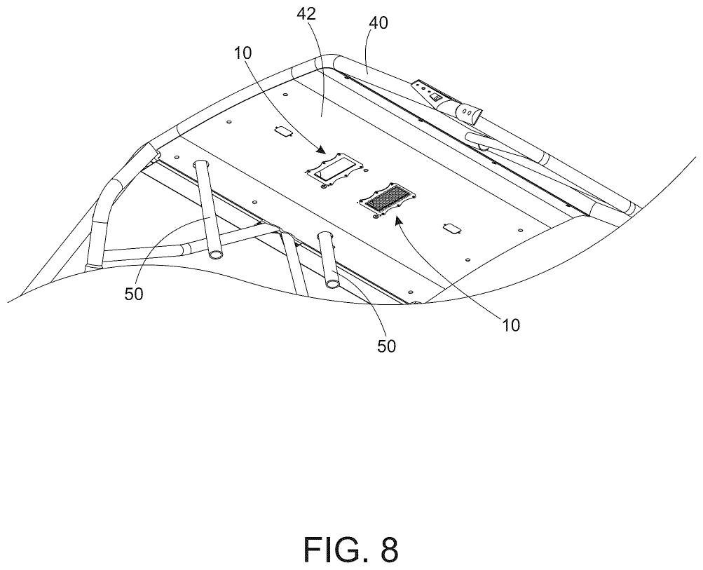

Referring to FIGS. 1-4, depicted is panel mounted clean air system 10 according to an embodiment. The system 10 generally comprises an air intake 12 with an opening 13, a fan 16 coupled to the air intake 12, and an outlet 18 coupled to the fan. The system 10 may include a filter 17 and a gasket 19. The filter 17 and the gasket 19 (see FIG. 5) may be coupled between a mounting bracket 14 and the air intake 12, wherein the filter 17 covers the opening 13 of the air intake 12 and the gasket 19 seals the sides of the filter 17 to ensure that air can only enter the intake through the filter 17. The mounting bracket 14 operates to couple the system 10 to a roof skin 42 of a vehicle 40 (see FIGS. 6-8). The mounting bracket 14 comprises apertures 15 that correspond to apertures 11 of the air intake 12.

In operation, the fan 18 operates to draw air in through the air intake 12, wherein the air is drawn through the filter 17 to clean the air before entering the air intake 12. The filter 17 may be a mesh screen or any other filtering media that operates to filter particulates like dust and the like from the air. The fan 16 directs the air through the outlet 18 to the specified location.

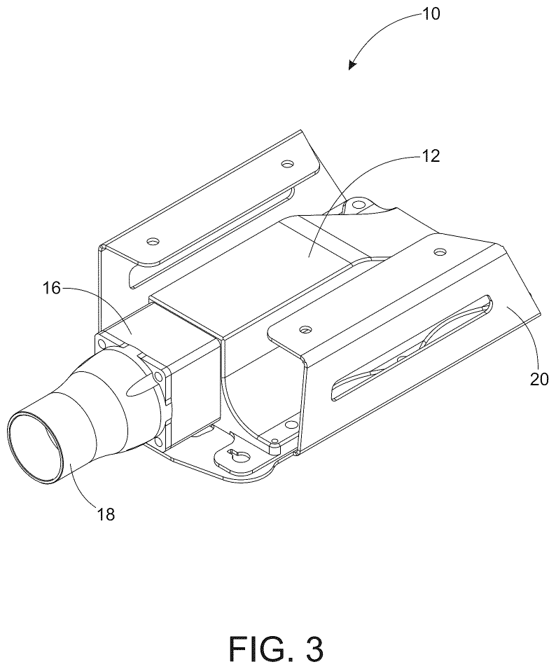

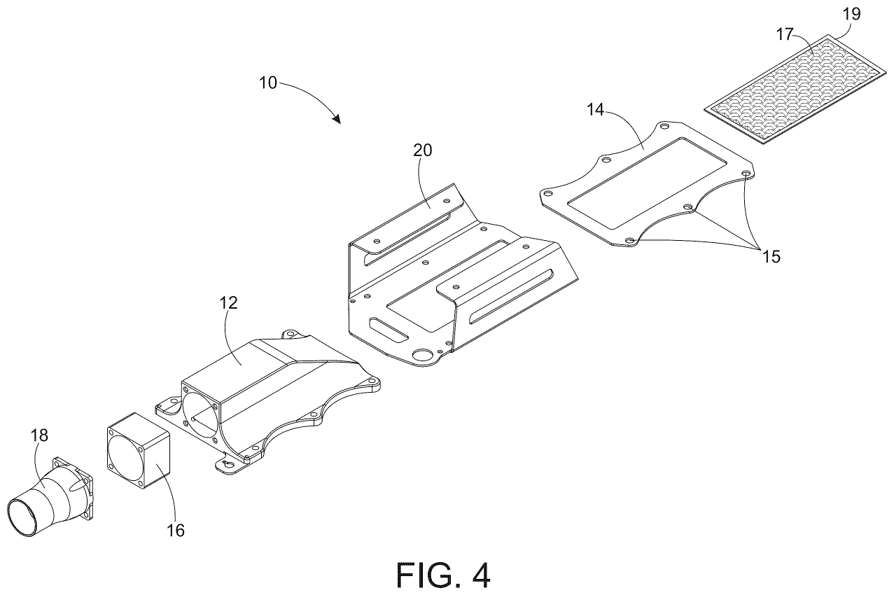

Referring specifically to FIGS. 3 and 4, the system 10 further includes an auxiliary mounting bracket 20. The auxiliary mounting bracket 20 is configured to mount the system 10 to any flat panel of a vehicle (not shown). The auxiliary bracket 20 may be coupled to the air intake 12 with the mounting bracket 14. This allows the system 10 to be coupled near a specified location that the user wishes to direct and force air into, such as, but not limited to, a cv axle. These types of components of a vehicle are prone to overheating and directing clean air helps in cooling and avoids dirt and other particulates that may damage the components.

One particular embodiment of use is depicted in FIGS. 6-8, wherein the panel mounted clean air system 10 is coupled to a roof skin 42 of a vehicle 40. The clean air system 10 may be coupled to the roof skin 42 by coupling the air intake 12 on a top side of the roof skin 42 and the mounting bracket 14 to a bottom side of the roof skin 42. The filter 17 and gasket 19 may be coupled on the top side or the bottom side of the roof skin 42. In operation, the fan 18 operates to draw air in through the air intake 12, wherein the air is drawn through the filter 17 to clean the air before entering the air intake 12. The fan 16 directs the air through the outlet 18 through a hose 50. The hose 50 may be extended through openings in the roof skin 42. The hose 50 may then be coupled to a helmet (not shown) of a driver and/or passenger. This allows clean air to be supplied to the riders of the vehicle. As shown in FIGS. 6-8 more than one panel mounted clean air system 10 may be coupled to a flat panel of the vehicle 40.

An embodiment may also include a method of using a panel mounted clean air system, the method comprising: coupling a panel mounted clean air system to a flat panel of a UTV; operating the fan to draw air in through the filter and the air intake; filtering the air in response to drawing the air in through the filter; and directing the air through the outlet to a specified location. In embodiments, the specified location includes a helmet, such as a helmet of a driver or a helmet of a passenger. In other embodiments, the specified location may be a cv axle. In embodiments, more than one system may be coupled to the flat panel of the vehicle.

It will be understood that in embodiments, the vehicle is an offroad vehicle such as, but not limited to a UTV. While it is shown that the vehicle is a UTV in the drawings, some embodiments may be adapted to use in other types of vehicles.

It will be understood that implementations are not limited to the specific components disclosed herein, as virtually any components consistent with the intended operation of a method and/or system implementation for a cage/chassis integrated air supply system may be utilized. Accordingly, for example, although particular hollow tubes, air input and output ports, hoses and other components are disclosed, such components may comprise any shape, size, style, type, model, version, class, grade, measurement, concentration, material, weight, quantity, and/or the like consistent with the intended operation of a method and/or system implementation for a cage/chassis integrated air supply system. Implementations are not limited to uses of any specific components, provided that the components selected are consistent with the intended operation of a method and/or system implementation for a cage/chassis integrated air supply system.

Accordingly, the components defining any a cage/chassis integrated air supply system implementation may be formed of any of many different types of materials or combinations thereof that can readily be formed into shaped objects provided that the components selected are consistent with the intended operation of a cage/chassis integrated air supply system implementation. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any cage/chassis integrated air supply system implementation may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A panel mounted clean air system comprising:
an air intake having an opening;
a fan coupled to the air intake; and
an outlet coupled to the fan, wherein;
the air intake is coupled to a flat panel of a vehicle; and
the fan operates to draw air in through the air intake and directs it through the outlet to a specified location.

2. The system of claim 1, further comprising a filter and a gasket coupled to the air intake, wherein the filter covers the opening of the air intake.

3. The system of claim 2, further comprising a mounting bracket, wherein the mounting bracket couples the air intake to the flat panel and couples the filter and the gasket to the air intake.

4. The system of claim 3, wherein the flat panel is a roof skin of the vehicle.

5. The system of claim 4, further comprising a hose coupled to the outlet the hose directing air to the specified location.

6. The system of claim 5, wherein the specified location is a helmet of a driver and/or passenger of the vehicle.

7. A panel mounted clean air system comprising:
an air intake having an opening;
a filter and a gasket coupled to the air intake, wherein the filter covers the opening of the air intake;
a fan coupled to the air intake;
an outlet coupled to the fan;
a mounting bracket; and
an auxiliary bracket, wherein:
the mounting bracket couples the air intake to the auxiliary bracket and couples the filter and the gasket to the air intake wherein;
the auxiliary bracket couples the air intake is to a flat panel of a vehicle; and
the fan operates to draw air in through the air intake and directs it through the outlet to a specified location.

8. The system of claim 7, wherein the flat panel is a side panel of the vehicle.

9. The system of claim 8, further comprising a hose coupled to the outlet, the hose directing air to the specified location.

10. The system of claim 9, wherein the specified location is a cv axle of the vehicle.

11. A method of using a panel mounted clean air system, the method comprising:
coupling a panel mounted clean air system to a flat panel of a UTV, the panel mounted clean air system comprising:
an air intake having an opening;
a filter and a gasket coupled to the air intake, wherein the filter covers the opening of the air intake;
a fan coupled to the air intake; and
an outlet coupled to the fan;
operating the fan to draw air in through the filter and the air intake;
filtering the air in response to drawing the air in through the filter; and
directing the air through the outlet to a specified location.

12. The method of claim 11, wherein the specified location is a helmet of a driver or passenger of the UTV.

13. The method of claim 11, wherein the specified location is a cv axle of the UTV.
